(19) United States
(12) Patent Application Publication
(10) Pub. No.: US 2019/0394144 A1
(43) Pub. Date: Dec. 26, 2019

(54) METHOD OF SPLITTING APPLICATION MESSAGES IN AN IP NETWORK

(71) Applicant: ORANGE, Paris (FR)

(72) Inventors: Jose Doree, Chatillon Cedex (FR); Jean-Claude Le Rouzic, Chatillon Cedex (FR)

(21) Appl. No.: 16/464,239

(22) PCT Filed: Nov. 20, 2017
(86) PCT No.: PCT/FR2017/053178

§ 371 Date: May 24, 2019

(30) Foreign Application Priority Data
Nov. 30, 2016 (FR) 1661718

(51) Int. Cl. H04L 12/861; H04W 28/06; H04L 12/805; H04L 12/741; H04L 29/06

(52) U.S. Cl. CPC H04L 49/9057; H04W 28/065; H04L 65/80; H04L 45/745; H04L 65/1006; H04L 47/36

(57) ABSTRACT

The invention relates to a method for splitting application messages in an IP (Internet Protocol) network, comprising the following steps: a) a node of the IP network, termed the first node, receives a message having to be transmitted to another node of the IP network, termed the second node; b) said first node compares the length of said message with the maximum transmission size MTU (Maximum Transmission Unit) characterizing the path between said first node and said second node; and if said length is greater than the MTU, c) the first node splits the message into at least two segments, and inserts each respective segment into a respective data packet of length less than or equal to the MTU; d) the first node transmits said data packets to the second node; and e) the second node assembles said segments so as to reconstruct said message. Said method is noteworthy in that, said message being an application message: during said step c), the first node inserts into each of said data packets a so-called positioning information item specifying the relative position in the message of the segment inserted into this data packet; and during said step e), the second node reconstructs the message with the aid of said positioning information items. Application to IP networks using a non-connected transport protocol such as the UDP protocol.

The present invention relates to communications networks of IP (“Internet Protocol”) type, and especially those among IP networks which are able to implement evolved session control protocols.

More particularly, the present invention relates to the means implemented in an IP network for transmitting very long application messages. By “application” is meant that these messages obey the standards relating to a certain computing application.

It is recalled that IP networks allow the broadcasting of conversational data, within the framework of services such as “Voice over IP” (VoIP), “Content Sharing”, or “Instant Messaging”.

It is also recalled that evolved session control protocols, such as the SIP protocol (initials standing for “Session Initiation Protocol”), use so-called “signaling” messages, which are messages allowing a terminal to request a connection with another terminal, or also messages signaling that a telephone line is occupied, or signaling that the called telephone is ringing, or else signaling that such telephone is connected to the network and can be reached in this or that way.

The SIP protocol has been defined by the IETF (Internet Engineering Task Force) in document RFC 3261. This protocol allows the establishment, modification and termination of multimedia sessions in a network using the IP protocol. The SIP protocol has thereafter been extended in particular in document RFC 3265; this extension defines events notification procedures.

The SIP protocol is used in particular in network infrastructures of IMS type (initials standing for “IP Multimedia Subsystem”). The IMS has been defined by the standardization body 3GPP (“Third Generation Partnership Project”) and TISPAN (“Telecommunications and Internet Converged Services and Protocols for Advanced Networking”). It is a network architecture introduced by the 3GPP for mobile networks, and then taken up by TISPAN for fixed networks. This architecture allows the dynamic establishment and the control of multimedia sessions between two clients as well as the reservation of resources at the level of the multimedia streams transport network. By virtue of this architecture, network operators can conveniently implement a management policy, provide a predetermined Quality of Service, and calculate the amounts to be billed to clients. The IMS currently makes it possible to access services of telephone, videophone, Presence and Instant Messaging type, whose interaction it also manages.

A fundamental problem which arises in IP networks at the level of the network layer (layer 3 of the OSI model) is that the routers can only transmit a data packet as a single block if the length of this packet does not exceed a certain maximum value, called “MTU” (initials standing for “Maximum Transmission Unit”). In certain systems (especially those complying with the IPv6 standard), the default behavior is to purely and simply destroy the overly long packets. Other systems possess means for splitting an overly long packet at the level of the network layer, so as to obtain several fragments which are transmitted one after the other; such splitting is called “fragmentation”.

However, it is well known (cf. for example the IETF documents RFC 3128, 4459 and 4963) that recourse to fragmentation is a source of numerous problems, and should be avoided. Indeed, it results especially in:

loss of efficiency in terms of bandwidth (fragments of a few useful bytes),

risk of de-sequencing of the fragments,

difficulty in passing through the NATs (initials standing for “Network Address Translator”) and the firewalls, which impose re-assembly,

obligation to retransmit all the fragments in case of loss of a single fragment, and

risk of attacks when re-assembling the fragments (cf. https://en.wikipedia.org/wiki/IP fragmentation attack).

Hence various techniques have emerged for avoiding the need to resort to fragmentation. One of these techniques consists in splitting the overly long data packets in the transport layer (layer 4 of the OSI model); the pieces resulting from this splitting are called “segments” if the transport protocol is TCP (initials standing for “Transmission Control Protocol”), or “chunks” if the transport protocol is SCTP (initials standing for “Stream Control Transmission Protocol”). These pieces have a length adapted to the MTU on the transmission path. It will be noted in this regard that documents RFC 1191, RFC 1181 and RFC 4821 explain how it is possible to determine the MTU in the case of connected protocols such as TCP and SCTP.

On the other hand, when a communication uses a non-connected transport mode, such as the UDP protocol (initials standing for “User Datagram Protocol”), it is not known how to split a data packet in the transport layer. This is regrettable since the UDP protocol (in particular) is very often used in current IP networks.

The present invention therefore relates, according to a first aspect, to a method of splitting application messages in an IP (Internet Protocol) network, comprising the following steps:
a) a node of the IP network, so-called first node, receives a message that has to be transmitted to another node of the IP network, so-called second node,
b) said first node compares the length of said message with the maximum transmission size MTU (Maximum Transmission Unit) characterizing the path between said first node and said second node, and, if said length is greater than the MTU,
c) the first node splits the message into at least two segments, and inserts each respective segment into a respective data packet of length less than or equal to the MTU,
d) the first node transmits said data packets to the second node, and
e) the second node assembles said segments so as to reconstruct said message.
   Said method is noteworthy in that, said message being an application message:
   during said step c), the first node inserts into each of said data packets a so-called positioning information item specifying the relative position in the message of the segment inserted into this data packet, and
   during said step e), the second node reconstructs the message with the aid of said positioning information items.

Thus, according to the invention, when an application message is too long, it is split in the application layer (layer 7 of the OSI model); more precisely, each message piece thus obtained, which will be called a “segment”, is encapsulated in a data packet of length compatible with the MTU. The splitting of messages in accordance with the invention will be called “segmentation” hereinafter.

By virtue of these provisions, for each path considered between two nodes according to the invention, it will be possible to make best use of the available capacities, while ensuring that no part of the message will be lost. Advantageously, the splitting method according to the invention is in particular applicable to communications using a non-connected transport mode, such as the UDP protocol.

According to particular characteristics, each of said data packets comprises the set of information items compulsory within the framework of the computing application governing said message.

By virtue of these provisions, said data packets are fully compliant with the standards governing said computing application.

According to other particular characteristics, each of said data packets comprises:
routing information items limited to the information items necessary for routing the data packet to said second node, and
a dedicated field containing an identifier of said message.

By virtue of these provisions, the space occupied by the routing information items in said data packets is reduced, thereby making it possible to increase the length of said segments, and therefore potentially to reduce the number of data packets necessary for transmitting the entire application message.

It will be noted that the messages split according to the present invention may be governed by all sorts of computing applications. This computing application may in particular consist of an IETF protocol such as HTTP (HyperText Transfer Protocol), MGCP (Media Gateway Control Protocol), or SMTP (Simple Mail Transfer Protocol).

According to particular characteristics, the computing application governing said message is the SIP protocol mentioned hereinabove.

Indeed, the splitting method according to the invention is advantageously applicable to messages complying with the SIP protocol, which is a historical user of the UDP transport protocol, especially for paths to user clients.

According to a second aspect, the invention relates to diverse devices.

It thus relates, firstly, to a node of an IP network, so-called first node, comprising means for, subsequent to the receipt of a message that has to be transmitted to another node of the IP network, so-called second node:
comparing the length of said message with the maximum transmission size MTU (Maximum Transmission Unit) characterizing the path between said first node and said second node,
splitting the message into at least two segments,
inserting each respective segment into a respective data packet of length less than or equal to the MTU, and
transmitting said data packets to the second node.
   Said first node is noteworthy in that, said message being an application message, said first node furthermore comprises means for inserting into each data packet a so-called positioning information item specifying the relative position in the message of the segment inserted into this data packet.

According to particular characteristics, each of said data packets comprises the set of information items compulsory within the framework of the computing application governing said message.

According to other particular characteristics, each of said data packets comprises:
routing information items limited to the information items necessary for routing the data packet to said second node, and
a dedicated field containing an identifier of said message.

The invention also relates, secondly, to a node of an IP network, so-called second node, comprising means for:
receiving data packets, and
extracting a message segment from each data packet.
   Said second node is noteworthy in that, said message being an application message, the second node furthermore comprises means for:
taking into account, in each of said data packets, a so-called positioning information item specifying the relative position in the message of the segment extracted from this data packet, and
using said positioning information items to assemble the segments of one and the same message.

According to particular characteristics, said first node and said second node are active at the SIP level.

According to other particular characteristics, an IP node such as described succinctly hereinabove comprises means for transmitting to another IP node the maximum transmission size MTU characterizing the path between these two nodes.

By virtue of these provisions, dual-learning of the same item of information is avoided, namely the MTU characterizing the path between these two nodes.

The advantages offered by these nodes are essentially the same as those offered by the correlative methods succinctly set forth hereinabove.

It will be noted that it is possible to embody these nodes in the context of software instructions and/or in the context of electronic circuits. It will also be noted that an IP network node can comprise at one and the same time the “first node” means and the “second node” means according to the invention.

According to a third aspect, the invention relates to a system for communicating application messages in an IP network, comprising at least one first node such as described succinctly hereinabove and at least one second node such as described succinctly hereinabove.

The invention is also aimed at a computer program downloadable from a communication network and/or stored on a medium readable by computer and/or executable by a microprocessor. This computer program is noteworthy in that it comprises instructions for the execution of the steps of the splitting method succinctly set forth hereinabove, when it is executed on a computer.

The advantages offered by this computer program are essentially the same as those offered by said method.

Other aspects and advantages of the invention will become apparent on reading the description detailed hereinbelow of particular embodiments given by way of nonlimiting examples.

We shall describe an embodiment of the invention in which the computing application governing the messages exchanged in a communication is the SIP control protocol. In this embodiment, the format of a data packet encapsulating a message segment will be called “SEGMENT pseudo-method”. It will be noted that the SEGMENT pseudo-method is not properly speaking a “method” within the meaning of the SIP protocol, but an extension of the SIP protocol applicable specifically to the splitting method according to the invention. This is why one speaks of “pseudo”-method, and this is why it is also possible to redefine the headers of data packets within the framework of this pseudo-method.

The segmentation according to the SEGMENT pseudo-method will preferably be implemented on each “SIP hop” of the IP network considered. The path between two network nodes which are active at the SIP level is called an “SIP hop”. A node active at the SIP level is characterized in that it generates an SIP request or response, or else inserts/removes a header Via in the SIP message in the course of processing, as commonly done by the UAC (User Agent Client), UAS (User Agent Server), proxy servers or B2BUA (Back-to-Back User Agent) of the SIP protocol. In particular, a node active at the SIP level generates or decrements the “Max-Forward” header in a request. The SEGMENT pseudo-method applies to any node active at the SIP level, irrespective of the context of usage (for example, IMS network, WebRTC, non-standardized VoIP solutions, or private networks).

The value of the MTU, denoted SIP_PATH_MTU_D, will preferably be determined for each “SIP hop”, and stored in the active nodes for each path. Indeed, at each “SIP hop” a different transport protocol (such as TCP, UDP, or SCT) may be used, and it is therefore indeed “SIP hop” by “SIP hop” that the MTU must be determined.

We shall begin by explaining how an active SIP node can determine the value of the MTU for an “SIP hop” of which this node is an end point. It will be noted in this regard that document RFC 4821, mentioned hereinabove, indicates (cf. Sections 9 and 10.4) that the determination of the MTU in the case of non-connected transport protocols must be carried out at the application level, and this is done by means of a mechanism consisting in generating test packets of variable length and in observing whether these test packets are received or lost. But the indications of document RFC 4821 are general; we shall now describe in detail how such a mechanism can be implemented for a communication according to the SIP protocol.

The proposed procedure for the acquisition of the SIP_PATH_MTU_D on a given “SIP hop” is based on the sending of a learning SIP request, which might for example be an OPTIONS message (but any other request may be appropriate), whose length will be made to vary. Numerous variants exist for varying the length of an SIP request; it is for example possible to use a message body of variable length, or a header (for example, a “User-Agent” header) of variable length.

The SIP node uses the standardized transaction automatons of the SIP protocol to transmit or retransmit the learning requests. Here is an example of such a request:

OPTIONS sip:client@NetworkFromOperator.com SIP/2.0
Call-ID: eA6e9NTaAA@10.29.67.130

### CSeq: 1 OPTIONS

From: <sip:pcscf@operator.com>;tag=eA6e9NTbAA
To: <sip:client@NetworkFromOperator.com>

### Via: SIP/2.0/UDP 10.29.67.130:5060;

branch=z9hG4bKf94075096

### Max-Forwards: 1

### Contact: <sip:10.29.67.130:5060>

Content-Type: application/probe
Content-Length: [testMTU]
<arbitrary string of characters of length [testMTU]>

It will be noted that the OPTIONS request hereinabove comprises a “Max-Forwards” header set to the value 1, thereby making it possible to target the next “SIP hop” directly.

Thereafter the SIP node having sent the learning message starts listening for a response from an opposite party. Here is an example response:

### SIP/2.0 200 OK

### Via: SIP/2.0/UDP 80.12.197.184:5060;

branch=z9hG4bKf94075096
Call-ID: eA6e9NTaAA@10.29.67.130

### CSeq: 1 OPTIONS

From: <sip:client@NetworkFromOperator.com>; tag=eA6e9NTbAA
To: <sip:pcscf@operator.com>;tag=rp7e9NTdAA

### Contact: <sip:10.29.67.130:5060>

### Content-Length: 0

In the example hereinabove, the sender of the learning message receives a response of SIP type 200 OK, but any SIP response (for example, “480 Temporarily unavailable”) may be appropriate for the needs of the learning procedure.

Under these conditions:

if a response is received, then the learning message has reached destination; consequently, the maximum size of the messages which is accepted on the path to this opposite party is at least equal to the size of said learning message;

if on the other hand no message is received in response, then the learning message has been lost, and therefore its length was too great.

On completion of the learning procedure, the value (or an estimation of the value) of SIP_PATH_MTU_D is thus available in the SIP computing application.

For a network node serving as connecting entity between an access network and a core network (such as a P-CSCF server in an IMS network), the procedure for discovering the MTU between this connecting entity and a client will preferably take place just after the initial registration of this client, and the implementation of this procedure will make it possible to store the MTU in the registration context associated with the client's contact address. The SIP_PATH_MTU_D will thus remain valid throughout the client's registration, and may be recalculated upon a new initial registration, so as to adapt to a possible modification of this path of the network.

The storage of the SIP_PATH_MTU_D in the registration context in such a way thereafter allows the client to implement the invention with any admissible transport protocol. The client will be able for example to transmit messages after having switched from UDP to TCP when the length of these messages is greater than (SIP_PATH_MTU_D—200 bytes), as required by document RFC 3261 mentioned hereinabove.

This information item can also be broadcast to an opposite party of the client, who will then be able advantageously to store it in their own registration context so as to utilize it in the same manner. This information item can for example be communicated in a header or the content of a message, for example a learning message in respect of the MTU.

Here for example is how a node active at the SIP level can transmit the value of SIP_PATH_MTU_D to an opposite party as parameter of a header such as “From” or “Via”, by using an SIP “generic-param” (the notion of “generic-param” is defined in document RFC 3261):

From:<sip:client@NetworkFromOperator.com>
tag=LC7e9NTgAA;SIP_PATH_MTU_D=5000

If the node active at the SIP level is an IMS core network node, such as an AS (initials standing for “Application Server”), an I-CSCF (initials standing for “Interrogating-Call Server Control Function”), an S-CSCF (initials standing for “Serving-Call Server Control Function”), or a BGCF (initials standing for “Breakout Gateway Control Function”), the learning procedure will be implemented when the “SIP hop” appears for the first time in a route. By “first time” is meant the fact that this “SIP hop” is not present in the locally stored tables. In order not to risk limitless storage, the indication of the MTU for an “SIP hop” that is not used for a predetermined duration will preferably be deleted.

The splitting method according to the invention, in the present embodiment, comprises the following steps.

According to a first step, an IP node, so-called first node, receives an SIP message (request or response), and notes that it must transmit this message to another IP node, so-called second node. It is assumed that this first node has previously discovered the MTU characterizing the path between the first node and the second node (by using, for example, the procedure described hereinabove), or has previously obtained the value of the MTU from the second node (by using, for example, the procedure also described hereinabove).

According to a second step, the first node compares the length of the received message with this MTU. We shall assume now that the length of the message is greater than the MTU.

According to a third step, the first node extracts from the SIP message received the set of compulsory SIP information items (such as specified in the Table 2 of chapter 20 of document RFC 3261), as well as those necessary for routing the message to its recipient; these information items comprise in particular the headers “Via”, “From”, “To”, “Cseq”, “Call-ID”, “Max-Forwards”, “Route”, “Record-Route”, “Contact”, as well as the first line of the message (“Request URI”).

The first node then splits the content of the message in such a way as to obtain several segments. Each respective segment will be transported in a message body of a respective SEGMENT pseudo-method of length less than or equal to the MTU.

As a so-called “optimized” variant, only the information items necessary for the routing of the SEGMENT pseudo-method to the second node (as opposed to the routing information items relating to several “SIP hop”) are recopied in the headers of the SEGMENT pseudo-method; a saving is thus made, in particular, in respect of the headers Record-Route, Via, From, Call-ID, CSeq, Max-Forwards, and Contact. However, within the framework of this variant, the first node furthermore includes in the SEGMENT pseudo-method a header, so-called identification header, containing an identifier (generated randomly, for example) characteristic of the message to be transmitted, and which will be called “SIP-PDU-Id”, this identifier SIP-PDU-Id therefore makes it possible to identify all the SEGMENT pseudo-methods relating to the same SIP message. By virtue of these provisions, the space occupied by the routing information items in the SEGMENT pseudo-methods is reduced, thereby making it possible to increase the length of said segments, and therefore potentially to reduce the number of SEGMENT pseudo-methods necessary to transmit the entire message. It will however be noted that this result is obtained at the price of a non-standard behavior in relation to the SIP standards.

Moreover, irrespective of the variant, the first node includes in each SEGMENT pseudo-method a so-called positioning header (which will be called “Segment-Size”) specifying the relative position in the message to be transmitted of the segment encapsulated in this pseudo-method; this positioning header will allow the second node to reconstruct this message, in particular if the segments are de-sequenced during transport. Thus, in the examples provided hereinbelow, the Segment-Size header specifies, in each SEGMENT pseudo-method, the numbers corresponding to the order of the bytes of the message to be transmitted that are encapsulated in this pseudo-method, as well as the total number of bytes of this message.

According to a fourth step, the first node transmits the SEGMENT pseudo-methods thus obtained to the second node.

Finally, according to a fifth step, the second node reconstructs the message by virtue of the positioning information item contained in the Segment-Size header, as well as, in the case of the optimized variant, by virtue of the information item contained in the SIP-PDU-Id header (if needed). The SIP protocol then performs, optionally, checks on the reconstructed message (validity, destination, origin, semantics, and so on and so forth), before transmitting it to the following “SIP hop” if the message has not reached its final destination.

We shall illustrate the present embodiment with a few numerical examples.

Let us assume, according to a first example, that an OPTIONS SIP request, of total length 1700 bytes (namely, 200 header bytes, and 1500 message body bytes), must be transmitted by a first node to a second node, the request being worded as follows:

OPTIONS sip:client@NetworkFromOperator.com SIP/2.0
Call-ID: eA6e9NTaAA@10.29.67.130

### CSeq: 1 OPTIONS

### Route: <sip:194.23.56.14 5067>

From: <sip:pcscf@operator.com>;tag=eA6e9NTbAA
To: <sip:client@NetworkFromOperator.com>

### Via: SIP/2.0/UDP 10.29.67.130:5060;

branch=z9hG4bKf94075096aaba6a952d7a9a630c70d9b333832

### Max-Forwards: 1

### Contact: <sip:10.29.67.130:5060>

Content-Type: application/probe

### Content-Length: 1500

<message body>

If the value of the MTU on the path is 1000 bytes, it will be necessary to use (at least) two SEGMENT pseudo-methods. In the so-called “optimized” variant, the transmission of the message then comprises a first pseudo-method, whose headers occupy (let us say) 100 bytes and of total length 1000 bytes, worded as follows:

SEGMENT sip:client@NetworkFromOperator.com SIP/2.0

### Route: <sip:194.23.56.14 5067>

To: sip:client@NetworkFromOperator.com

### Segment-Size: 1-900/1700

### SIP-PDU-Id: 456@#Th7j8k563ty7K

OPTIONS sip:client@NetworkFromOperator.com SIP/2.0Call-ID: eA6e9NTaAA@10.29.67.130

### CSeq: 1 OPTIONS

From: <sip:pcscf@operator.com>;tag=eA6e9NTbAA
To: <sip:client@NetworkFromOperator.com>

### Via: SIP/2.0/UDP 10.29.67.130:5060;

branch=z9hG4bKf94075096aaba6a952d7a9a630c70d9b333832

### Max-Forwards: 1

### Contact: <sip:10.29.67.130:5060>

Content-Type: application/something

### Content-Length: 1500

<N₁ first bytes of the content of the OPTIONS method>
where, since the MTU equals 1000 bytes:

N₁=1000−100 (SEGMENT headers)−200 (OPTIONS headers) =700 bytes.

Still in the so-called “optimized” variant, the transmission of the message furthermore comprises a second pseudo-method, whose headers occupy (let us say) 100 bytes and of total length 1000 bytes, worded as follows:

SEGMENT sip:client@NetworkFromOperator.com SIP/2.0

### Route: <sip:194.23.56.14 5067>

To: sip:client@NetworkFromOperator.com

### Segment-Size: 901-1700/1700

### SIP-PDU-Id: 456@#Th7j8k563ty7K

<N₂ last bytes of the content of the OPTIONS method>
where, since the content of the OPTIONS method (that is to say the body of the message) comprises 1500 bytes:

N₂=1500−N₁=800 bytes.

According to a second example, let us assume that an opposite party wishes to transmit an SIP response 200 OK, of total length 1400 bytes (namely, 200 header bytes, and 1200 message body bytes), worded as follows:

### SIP/2.0 200 OK

### Via: SIP/2.0/UDP 80.12.197.184:5060;

branch=z9hG4bK_IMSCA0720430.000_33323c28bbb663570d434d94f66752e3;

### Call-ID: LC7e9NTfAA@10.29.67.132

### CSeq: 1 OPTIONS

From: <sip:client@NetworkFromOperator.com>;tag=LC7e9NTgAA
To: <sip:pcscf@operator.com>;tag=rp7e9NTdAA

### Contact: <sip:10.29.67.130:5060>

Content-Type: application/somethingElse

### Content-Length: 1200

<message body>

If the value of the MTU on the path is 1000 bytes, it will be necessary to use (at least) two SEGMENT pseudo-methods. In the so-called “optimized” variant, the transmission of the message then comprises a first pseudo-method, whose headers occupy (let us say) 100 bytes and of total length 1000 bytes, worded as follows:

### SEGMENT 200 OK

### Via: SIP/2.0/UDP 80.12.197.184:5060;

branch=z9hG4bK_IMSCA0720430.000_33323c28bbb663570d434d94f66752e3;

### Segment-Size: 1-900/1400

SIP-PDU-Id: fsdRET6hrtL45

### SIP/2.0 200 OK

### Via: SIP/2.0/UDP 80.12.197.184:5060;

branch32 z9hG4bK_IMSCA0720430.000_33323c28bbb663570d434d94f66752e3;

### Call-ID: LC7e9NTfAA@10.29.67.132

### CSeq: 1 OPTIONS

From: <sip:client@NetworkFromOperator.com>;tag=LC7e9NTgAA
To: <sip:pcscf@operator.com>;tag=rp7e9NTdAA

### Contact: <sip:10.29.67.130:5060>

Content-Type: application/somethingElse

### Content-Length: 1200

<M₁ first bytes of the content of the SIP method 200 OK>
where, since the MTU equals 1000 bytes:

M₁=1000−100 (SEGMENT headers)−200 (SIP headers 200 OK) =700 bytes.

Still in the so-called “optimized” variant, the transmission of the message furthermore comprises a second pseudo-method, whose headers occupy (let us say) 100 bytes and of total length 1000 bytes, worded as follows:

### SEGMENT 200 OK

### Via: SIP/2.0/UDP 80.12.197.184:5060;

branch=z9hG4bK_IMSCA0720430.000_33323c28bbb663570d434d94f66752e3;

### Segment-Size: 901-1400/1400

SIP-PDU-Id: fsdRET6hrtL45
<M₂ last bytes of the content of the SIP method 200 OK>
where, since the content of the SIP method 200 OK (that is to say the body of the message) comprises 1200 bytes:

M₂=1200−M₁=500 bytes.

It will be noted that the first line, as well as the routing headers, of the SEGMENT pseudo-methods are different for the encapsulation of an SIP request by comparison with an SIP response, since the routing of the requests and of the responses according to the SIP protocol does not utilize the same information.

As a variant, it is possible to refrain from distinguishing the requests from the responses in the SEGMENT pseudo-method, in which case only the “Segment-Size” and “SIP-PDU-Id” headers will be present. The first line (Request-URI) of the SEGMENT pseudo-method then contains the contact address of the next SIP node.

The compatibility of a node of the IP network with the present invention can be conveniently indicated in the SIP header “Allow” (known per se). No new negotiation mechanism is necessary for this purpose: if a node active at the SIP level wishes to discover the compatibility of an opposite party with the SEGMENT pseudo-method on an “SIP hop”, it suffices for it to send an OPTIONS method with the “Max-Fowards” header set to the value 1; if the response of the opposite party includes an SIP header “Allow” mentioning the SEGMENT pseudo-method (in addition to the SIP methods accepted by this node), then the opposite party is compatible with this pseudo-method.

Generally, the present invention can be implemented within the nodes of an IP network, by means of software components and/or hardware components.

The software components will be able to be integrated into a conventional computer program for network node management. This is why, as indicated hereinabove, the present invention also relates to a computing system. This computing system comprises in a conventional manner a central processing unit controlling by signals a memory, as well as an input unit and an output unit. Moreover, this computing system can be used to execute a computer program comprising instructions for the implementation of any one of the splitting methods according to the invention.

Indeed, the invention is also aimed at a computer program downloadable from a communication network comprising instructions for the execution of the steps of a splitting method according to the invention, when it is executed on a computer. This computer program can be stored on a medium readable by computer and can be executable by a microprocessor.

This program can use any programming language, and take the form of source code, object code, or of code intermediate between source code and object code, such as in a partially compiled form, or in any other desirable form.

The invention is also aimed at an irremovable, or partially or totally removable, information medium readable by a computer, and comprising instructions of a computer program such as mentioned hereinabove.

The information medium can be any entity or device capable of storing the program. For example, the medium can comprise a storage means, such as a ROM, for example a CD ROM or a microelectronic circuit ROM, or a magnetic recording means, such as a hard disk, or else a USB key (“USB flash drive”).

Moreover, the information medium can be a transmissible medium such as an electrical or optical signal, which can be conveyed via an electrical or optical cable, by radio or by other means. The computer program according to the invention can in particular be downloaded over a network of Internet type.

As a variant, the information medium can be an integrated circuit in which the program is incorporated, the circuit being adapted to execute or to be used in the execution of any one of the splitting methods according to the invention.

1. A method of splitting application messages in an IP (Internet Protocol) network, comprising the following:
a) a node of the IP network, so-called first node, receives a message that has to be transmitted to another node of the IP network, so-called second node,
b) said first node compares the length of said message with the maximum transmission size MTU (Maximum Transmission Unit) characterizing the path between said first node and said second node,
and, if said length is greater than the MTU,
c) the first node splits the message into at least two segments, and inserts each respective segment into a respective data packet of length less than or equal to the MTU,
d) the first node transmits said data packets to the second node, and
e) the second node assembles said segments so as to reconstruct said message, wherein said message being an application message:
during said c), the first node inserts into each of said data packets a so-called positioning information item specifying the relative position in the message of the segment inserted into this data packet, and
during said e), the second node reconstructs the message with the aid of said positioning information items.

2. The splitting method as claimed in claim 1, wherein each of said data packets comprises the set of information items compulsory within the framework of the computing application governing said message.

3. The splitting method as claimed in claim 1, wherein each of said data packets comprises:
routing information items limited to the information items necessary for routing the data packet to said second node, and
a dedicated field containing an identifier of said message.

4. The splitting method as claimed in claim 1, wherein the computing application governing said message is the SIP (Session Initiation Protocol) session control protocol.

5. A node of an IP (Internet Protocol) network, so-called first node, comprising means for, subsequent to the receipt of a message that has to be transmitted to another node of the IP network, so-called second node:
comparing the length of said message with the maximum transmission size MTU characterizing the path between said first node and said second node,
splitting the message into at least two segments,
inserting each respective segment into a respective data packet of length less than or equal to the MTU, and
transmitting said data packets to the second node, wherein said message being an application message, said first node furthermore comprises means for inserting into each data packet a so-called positioning information item specifying the relative position in the message of the segment inserted into this data packet.

6. The node of an IP network as claimed in claim 5, wherein each of said data packets comprises the set of information items compulsory within the framework of the computing application governing said message.

7. The node of an IP network as claimed in claim 5, wherein each of said data packets comprises:
routing information items limited to the information items necessary for routing the data packet to said second node, and
a dedicated field (SIP-PDU-Id) containing an identifier of said message.

8. A node of an IP (Internet Protocol) network, so-called second node, comprising means for:
receiving data packets, and
extracting a message segment from each data packet,
wherein said message being an application message, said second node furthermore comprises means for:
taking into account, in each of said data packets, a so-called positioning information item specifying the relative position in the message of the segment extracted from this data packet, and
using said positioning information items to assemble the segments of one and the same message.

9. The node of an IP network as claimed in claim 5, wherein it is active at the SIP (Session Initiation Protocol) level.

10. The node of an IP network as claimed in claim 5, said node comprising means for transmitting to another IP node the maximum transmission size MTU (Maximum Transmission Unit) characterizing the path between these two nodes.

11. A system for communicating application messages in an IP (Internet Protocol) network, comprising:
at least one first node of an IP (Internet Protocol) network, so-called first node, comprising means for, subsequent to the receipt of a message that has to be transmitted to another node of the IP network, so-called second node:
comparing the length of said message with the maximum transmission size MTU characterizing the path between said first node and said second node,
splitting the message into at least two segments,
inserting each respective segment into a respective data packet of length less than or equal to the MTU, and
transmitting said data packets to the second node,
wherein said message being an application message, said first node furthermore comprises means for inserting into each data packet a so-called positioning information item specifying the relative position in the message of the segment inserted into this data packet, and
at least one second node comprising means for:
receiving data packets, and
extracting a message segment from each data packet,
wherein said message being an application message, said second node furthermore comprises means for:
taking into account, in each of said data packets, a so-called positioning information item specifying the relative position in the message of the segment extracted from this data packet, and
using said positioning information items to assemble the segments of one and the same message.

12. An irremovable, or partially or totally removable means for storing data comprising computerized program code instructions for the execution of a splitting method comprising the following:
a) a node of the IP network, so-called first node, receives a message that has to be transmitted to another node of the IP network, so-called second node,
b) said first node compares the length of said message with the maximum transmission size MTU (Maximum Transmission Unit) characterizing the path between said first node and said second node,
and, if said length is greater than the MTU,
c) the first node splits the message into at least two segments, and inserts each respective segment into a respective data packet of length less than or equal to the MTU,
d) the first node transmits said data packets to the second node, and
e) the second node assembles said segments so as to reconstruct said message,
wherein said message being an application message:
during said c), the first node inserts into each of said data packets a so-called positioning information item specifying the relative position in the message of the segment inserted into this data packet, and
during said e), the second node reconstructs the message with the aid of said positioning information items.

13. A computer program downloadable from a communications network and/or stored on a medium readable by computer and/or executable by a microprocessor, characterized in that it comprises instructions for the execution of the steps of a splitting method, when it is executed on a computer, the splitting method comprising the following:
a) a node of the IP network, so-called first node, receives a message that has to be transmitted to another node of the IP network, so-called second node,
b) said first node compares the length of said message with the maximum transmission size MTU (Maximum Transmission Unit) characterizing the path between said first node and said second node,
and, if said length is greater than the MTU,
c) the first node splits the message into at least two segments, and inserts each respective segment into a respective data packet of length less than or equal to the MTU,
d) the first node transmits said data packets to the second node, and
e) the second node assembles said segments so as to reconstruct said message,
wherein said message being an application message:
during said c), the first node inserts into each of said data packets a so-called positioning information item specifying the relative position in the message of the segment inserted into this data packet, and
during said e), the second node reconstructs the message with the aid of said positioning information items.
